(19) United States
(12) Patent Application Publication
(10) Pub. No.: US 2009/0031122 A1
(43) Pub. Date: Jan. 29, 2009

(54) Mechanism for restoring an apparatus to factory default

(75) Inventors: Edin Hodzic, Pleasanton, CA (US); Brian Kindle, Sunnyvale, CA (US); Gilbert Flamino, San Carlos, CA (US)

Correspondence Address: SHEMWELL MAHAMEDI LLP, 4880 STEVENS CREEK BOULEVARD, SUITE 201, SAN JOSE, CA, 95129-1034, US

(73) Assignee: WOND, LLC

(21) Appl. No.: 11/556,333

(22) Filed: Nov. 3, 2006

(51) Int. Cl. G06F 9/00

(52) U.S. Cl. 713/1

(57) ABSTRACT

A mechanism for restoring an apparatus to factory default is disclosed. A reset mechanism is provided in an electronic apparatus and can be activated or pressed when the electronic apparatus is powered off. A detection circuit, when the apparatus is powered on, is configured to detect whether the reset mechanism has been activated when the apparatus was powered off. If it is determined that the reset mechanism was activated, the detection circuit activates a resetting process that sets the apparatus back to the factory default status.

### BACKGROUND

1. Technical Field

The present invention relates generally to the area of electronic devices, and more particularly to a mechanism for restoring an apparatus to the factory default without turning on a power switch or keeping a power switch on.

2. Description of the Related Art

There are many cases that require a user to set an electronic device to the original factory default status. In the category of computing devices, a reset button (either in software or hardware) is provided to allow a device to get back to the original manufacturer status. For example, in a menu for a network router, a user may always see a description similar to “If you believe you may have changed settings and can't get the router working right, you may restore the router back to the way it was the day you bought it. Click the Tools tab and then the System button. Then click the Restore button on that page. If you have locked yourself out of your router, you can do a hardware reset. There's a button at the back (or sometimes the bottom) of the router with the word RESET next to it. Once pressed, the router will restart and be reset to the factory default. However, the operation as instructed in the menu requires that the router be powered on. In fact, all electronic devices, if equipped with such a reset button, must be powered on to take effect when the reset button is activated.

In some applications, inconvenience has been experienced. For example, when a buyer returns a newly purchased computer to a store, the buyer is sometimes required to reformat the hard disk in the computer and set the computer back to its factory default status so that the store can resell the computer. As the capacity of a hard disk increases, it takes a long time to reformat the hard disk even though the user may have just installed an operating system without even loading any other data.

Thus, there is a need for a mechanism to reset an electronic device to the factory default status without turning or keeping the power switch on.

### SUMMARY

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

Broadly speaking, the present invention is related to a mechanism for restoring an apparatus to factory default. According to one aspect of the present invention, a reset mechanism is provided in an electronic apparatus and can be activated or pressed when the electronic apparatus is powered off. A detection circuit, when the apparatus is powered on, is configured to detect whether the reset mechanism has been activated when the apparatus was powered off. If it is determined that the reset mechanism was activated, the detection circuit activates a resetting process that sets the apparatus back to the factory default status.

The present invention can be advantageously used in devices that include a sizable storage space because such a storage space would require a substantial time to be restored. Without explicitly turning on a device, a reset mechanism designed in accordance with one embodiment of the present invention can be activated. The resetting process takes place before a normal operation of the device starts when the device is powered on next time. In a perspective, the present invention blends a resetting process with a starting process of a device so that the burden on a provider is shifted or diffused. The provider may be a service provider, a store, a clerk or any personnel responsible for restoring or reselling returned goods. In contrast to the prior art devices that require a device to be powered on for the resetting process to proceed, the present invention does not require a device to be powered on to effectuate a resetting process.

Other objects, features, advantages, benefits of the invention will become more apparent from the following detailed description of a preferred embodiment, which proceeds with reference to the accompanying drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1 shows an electronic device with a pinhole located on the bottom of the device;

FIG. 2 shows a functional block diagram that may be implemented in an electronic device, according to one embodiment of the present invention; and

FIG. 3 shows a display that may be used when the resetting process is in progress.

### DETAILED DESCRIPTION OF THE INVENTION

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments mutually exclusive of other embodiments. Further, the order of blocks in process, flowcharts or functional diagrams representing one or more embodiments, if any, do not inherently indicate any particular order nor imply limitations in the invention.

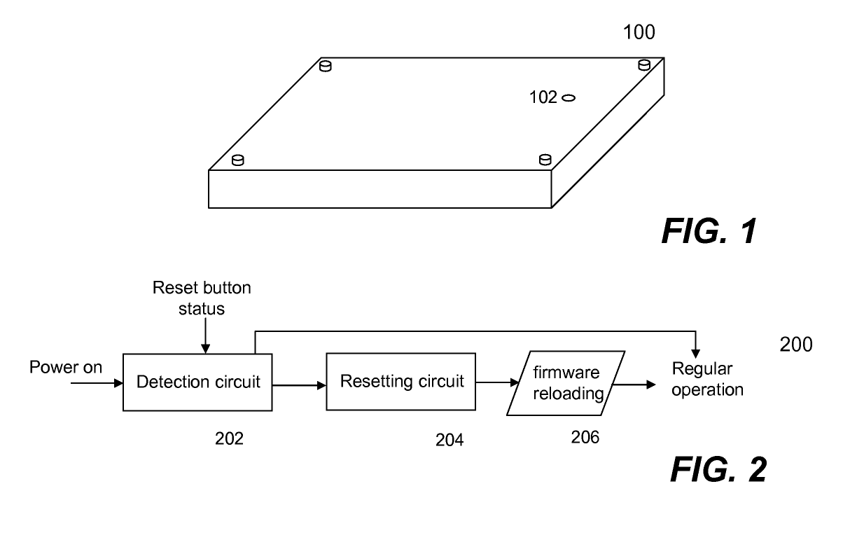

Referring now to the drawings, in which like numerals refer to like parts throughout the several views. FIG. 1 shows an electronic device 100 with a pinhole 102 located on the bottom of the device. The pinhole 102 includes a button that can be activated to reset the electronic device 100 to a default status predetermined by a manufacturer thereof. One of the features in the present invention is that such a reset button can be activated without explicitly requiring the device to be powered on. As will be further detailed below, due to the activation of the reset button, the device is configured to turn itself into a resetting process the next time the device is turned on. As a result, a store selling such devices designed in accordance with the present invention would not require a customer who just returned a device or a store clerk to manually turn on the device and reset the device. The present invention may be advantageously used in devices that include a storage space with sizeable capacity (e.g., greater than 100 GBytes).

According to one embodiment of the present invention, FIG. 2 shows a functional block diagram 200 that may be implemented in an electronic device. The diagram 200 includes a detection circuit 202 and a resetting circuit 204. When the electronic device is switched on, the detection circuit 202 detects whether a reset button has even been activated before the device is witched on. Depending on implementation, there may be several ways to detect whether a reset button has been activated when the device is power off. One example is to have a mechanical setting that changes its position after the reset button is pressed. Another example is to have a small circuit powered by a battery that is typically used to keep a clock running in the device while the device is power off.

In any case, when the detection circuit 202 detects that the reset button was indeed pressed before the device is switched on, the detection circuit 202 sends out a command signal (e.g., a pulse) that activates the resetting circuit 204. In one embodiment, the resetting circuit 204 generates all types of signals necessary to cause all changeable statuses back to the original default values. In another embodiment, the resetting circuit 204 generates the default values to restore all customer-changeable values. In still another embodiment, the resetting circuit 204 generates a command signal that activates a firmware reloading process 206 that reloads a copy of original firmware to overwrite whatever that may have been changed. In any case, all factory default values and statues are restored before the normal operation starts.

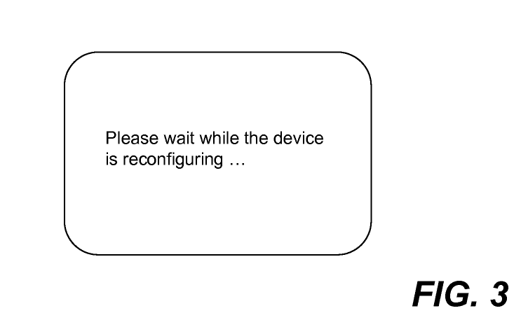

On the other end, if the detection circuit 202 detects that the reset button was not pressed before the device is switched on, the detection circuit 202 causes the device to go to the normal operation immediately. FIG. 3 shows a display that may be used when the resetting process is in progress.

In one embodiment, a media device includes a storage space with a capacity of over 100 Gbytes. When the media storage is obtained (e.g., bought or shipped), a user may turn on and start to play with the device. In some case, the user may start to personalize the device by setting the environment to his/her own taste. Later, the user decides not to keep the device. Typically, the user would not bother to erase his/her settings or any data he/she may have put on. Evidently reformatting the storage in the device would be very ineffective when the device is returned. In accordance with the present invention, all need to be done is to simply press a reset button in a pinhole. The device is reconditioned and packaged for a new user. When a new user receives the device, upon turning on a power switch, the user sees an indicator that the device is reconfiguring itself, presumably it is a process of any new type of computing device. When the indicator is gone, the normal operation starts.

When a media device is used to receive media services from a server (e.g., a headend), the media device will send a status to the server after the media device is connected online. A media device that has been reset can facilitate the server to close a relationship between the media device and the server. In general, a service provider prefers to maintain accounts that continue to receive services therefrom. When a media device was tried and later returned, an account as a result of the trial is preferably removed from the account database. In one embodiment, a retailer or a distributor of media devices is provided a type of incentive to reset a returned device designed in accordance with the present invention. Next time, when the returned box is turned on and connected online, the service is notified that the account for the previous owner shall be removed, and at the same time, another user of the returned box would not feel that the box was used.

From another perspective, the present invention blends the resetting process with a starting process of a device so that the burden on a provider is shifted or diffused. The provider may be a service provider, a store, a clerk or any personnel responsible for reconditioning, reselling or reshipping returned goods. In contrast to the prior art devices that require a device to be powered on for the resetting process to proceed, the present invention does not require a device to be powered on to effectuate a resetting process. This is achieved by implementing a detection circuit to detect whether a reset button has been pressed while the device is power off.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

We claim:

1. An apparatus comprising:
a reset mechanism;
a detection circuit, when the apparatus is powered on, to detect whether the reset mechanism has been activated when the apparatus was powered off,
wherein the detection circuit activates a resetting process when if the detection circuit detects that the reset mechanism has been activated when the apparatus was powered off.

2. The apparatus as recited in claim 1, wherein the reset mechanism includes a reset button in a pinhole.

3. The apparatus as recited in claim 1, wherein the reset mechanism is coupled to a battery so an activation of the reset mechanism is preserved till the apparatus is power on.

4. The apparatus as recited in claim 1, further including a resetting circuit coupled to the detection circuit, the resetting circuit, upon receiving a signal from the detection circuit, generates all types of signals necessary to cause all changeable statuses in the apparatus back to original default values.

5. The apparatus as recited in claim 1, further including a resetting circuit coupled to the detection circuit, the resetting circuit, upon receiving a signal from the detection circuit, restore all customer-changeable values.

6. The apparatus as recited in claim 1, further including a resetting circuit coupled to the detection circuit, the resetting circuit, upon receiving a signal from the detection circuit, restore generates a command signal that activates a firmware reloading process.

7. The apparatus as recited in claim 6, further wherein the firmware reloading process reloads a copy of original firmware to overwrite whatever that may have been changed.

8. The apparatus as recited in claim 1, wherein the resetting process involves erasing user data in a hard disk in the apparatus.

9. The apparatus as recited in claim 1, wherein the resetting process involves reformatting a hard disk in the apparatus.

10. The apparatus as recited in claim 1, wherein the reset mechanism is reset at a distribution place when the apparatus is returned by a first user.

11. The apparatus as recited in claim 10, wherein the distribution place is a retail store that is provided an incentive to reset the apparatus returned by the first user.

12. The apparatus as recited in claim 11, wherein, when the apparatus is used by a second user and powered on, the apparatus undergoes a resetting process and sends out a status to a server, the status causes the server to remove a relationship originally established between the first user and the server.
